(19) United States
(12) Patent Application Publication
(10) Pub. No.: US 2017/0367425 A1
(43) Pub. Date: Dec. 28, 2017

(54) STRUCTURE FOR FIXING RIDING RECORDER WITH HELMET VISOR FASTENER

(71) Applicant: NAVSTAR ELECTRONICS CO., LTD., New Taipei City (TW)

(72) Inventor: Chi-Hsiu CHEN, New Taipei City (TW)

(21) Appl. No.: 15/193,114

(22) Filed: Jun. 27, 2016

(51) Int. Cl. A42B 3/04; A42B 3/22; B60Q 9/00; H04N 7/18; H04N 5/225

(52) U.S. Cl. CPC A42B 3/046; H04N 7/183; H04N 5/2254; A42B 3/042; B60Q 9/00; A42B 3/221; H04N 5/2253

(57) ABSTRACT

Disclosed is a structure for fixing a riding recorder with helmet visor fasteners, including a visor, which is provided, in the inside thereof, with a plurality of first coupling members so as to be attached to a helmet with the first coupling members. A monitoring unit is mounted to a bottom of the visor and the monitoring unit includes at least one camera lens and a storage element such that when the monitoring unit is activated, the camera lens is operable to take images and stores the data of the images in the storage element.

### (A) TECHNICAL FIELD OF THE INVENTION

The present invention relates generally to a riding monitoring device, and more particularly to a riding monitoring device that possesses functions of both a riding recorder and a speeding detection alarm and comprises helmet visor fasteners that are directly engageable with a helmet visor.

### (B) DESCRIPTION OF THE PRIOR ART

For driving and riding safety, the traffic safety management agency of almost all the countries around the world use speeding photographing measure for fining and punishing the drivers or riders in order to prevent drivers or riders from driving or riding over speeds. The speeding photographing devices that are commonly used to detect the speeds of vehicles generally include stationary speeding photographing devices, police laser gun based speeding photographing systems, GPS (Global Positioning System) based photographing devices, and laser detection based speeding photographing devices. With the advance of technology and science, better devices for photographing speeding vehicles will be developed and available in the future.

Drivers often purchase and install speeding detection alarms in their vehicles to avoid being photographed due to speeding or to provide reminder for reducing speed simply for driving safety purposes. The speeding detection alarm may detect the existence and operation of one or multiple ones of the above mentioned speeding photographing devices so that alarms such as beeping sounds or lighting may be issued to warn the driver, allowing the driver to timely reduce the speed. The known speeding detection alarms that are currently available in the market are generally designed for use in automobiles. Heretofore, there was no device of similar functions proposed and available in the market for motorcycle riders. This certainly causes inconvenience of the motorcycle riders.

For areas where motorcycles have been widely used as a regular transportation measure, riding recorders are generally available but do not include the function of speeding detection alarm. Thus, further improvement may be needed for riding safety of motorcycle riders.

In view of the above, the present invention aims to provide a solution to overcome the above problems.

### SUMMARY OF THE INVENTION

In view of the above problems, the present invention provides a structure for fixing a riding recorder with helmet visor fasteners, which comprises: a visor, which is provided, in the inside thereof, with a plurality of first coupling members so as to be attached to a helmet with the first coupling members. A monitoring unit is mounted to a bottom of the visor and the monitoring unit comprises at least one camera lens and a storage element such that when the monitoring unit is activated, the camera lens is operable to take images and stores the data of the images in the storage element.

The primary object of the structure for fixing a riding recorder with helmet visor fasteners according to the present invention is as follows. In view of the fact that an existing helmet comprises a plurality of fasteners provided thereon for mounting and fixing a visor to the helmet and such fasteners are in the form of male and female fasteners that mate each other for coupling the visor and the helmet, a user does not need to install an additional support frame for mounting and supporting a riding recorder and/or a speeding detection alarm, so that the use is made easy and convenient and detachment can be done easily. For manufacturers, there is also no need to manufacture the support frame so that the manufacture cost can be reduced and the production and assembly performance can be improved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is a schematic view illustrating assembly and use of the present invention.

FIG. 3 is a schematic view showing the present invention in an assembled state, posterior to the state illustrated in FIG. 2.

FIG. 4 is block diagram illustrating the structure of a monitoring unit according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

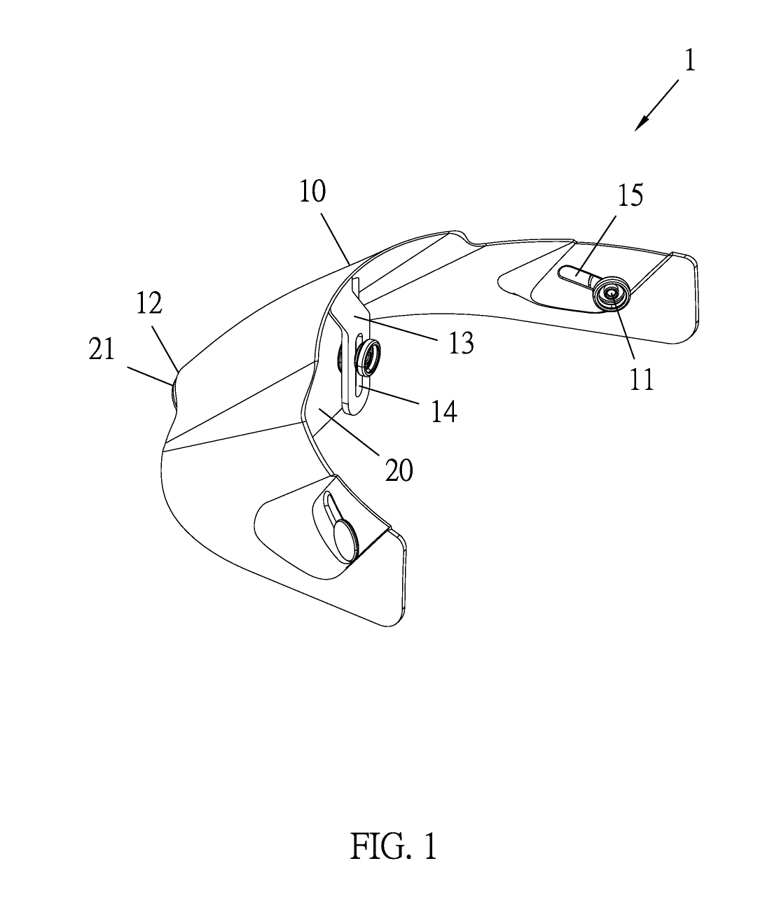

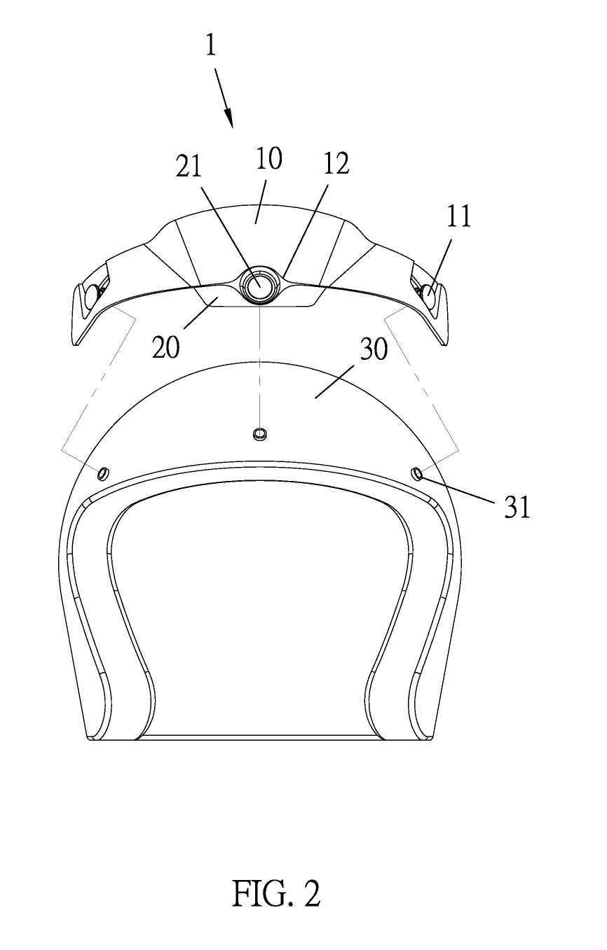

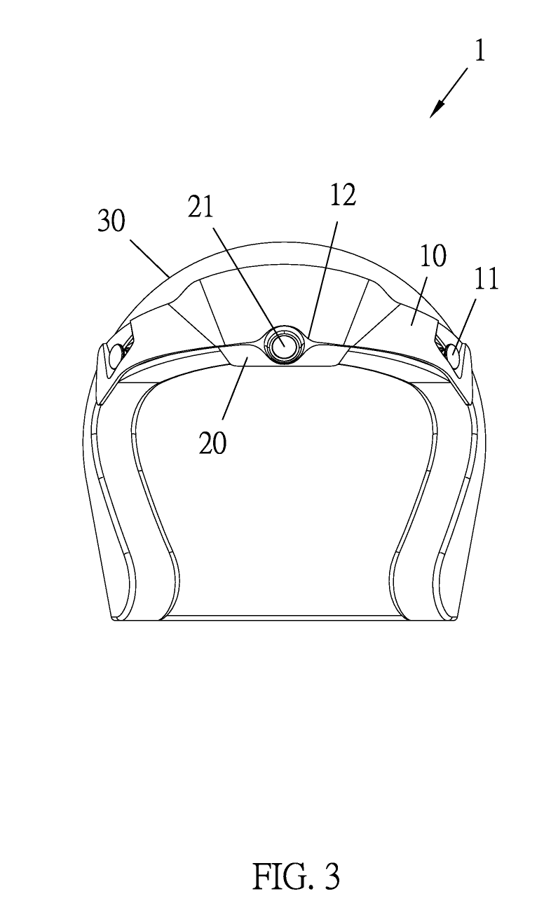

Referring to FIGS. 1-3, the present invention provides a structure for fixing a riding recorder with helmet visor fasteners, which is generally designated at 1, and comprises: at least one visor 10 and a monitoring unit 20, which will be individually described as follows:

The visor 10 comprises a plurality of first coupling members 11 that are mounted in the inside thereof The visor 10 has an arc configuration. The visor 10 has a bottom having a front edge that is recessed upwards to define a notch 12.

The monitoring unit 20 is mounted to the bottom of the visor 10. The monitoring unit 20 comprises at least one the camera lens 21 and a storage element 22, so that when the monitoring unit 20 is activated and in operation, photographing or video recording can be conducted with the camera lens 21 and data of images so obtained are stored in the storage element 22.

The camera lens 21 is received and fixed in the notch 12. The visor 10 is further provided, on the bottom thereof, with a connection member 13 that extends vertically downward. The first coupling members 11 are respectively mounted to an inner side of the connection member 13 and inner sides of two ends of the visor 10.

The connection member 13 and two side portions of the visor 10 are respectively provided with a first adjustment hole 14 and two second adjustment holes 15. The first coupling members 11 are respectively set in the first adjustment hole 14 and the second adjustment holes 15, so that the first coupling members 11 are respectively movable in the first adjustment hole 14 and the second adjustment holes 15 for adjusting an angle of the camera lens 21.

The visor 10 is combinable with a helmet 30. The helmet 30 has a front face in which a plurality of second coupling members 31 is provided so that the first coupling members 11 are respectively engageable and thus mate and couple with the second coupling members 31 in a detachable manner

The first coupling members 11 and the second coupling members 31 can be male and female fasteners, respectively, which are mateable with each other.

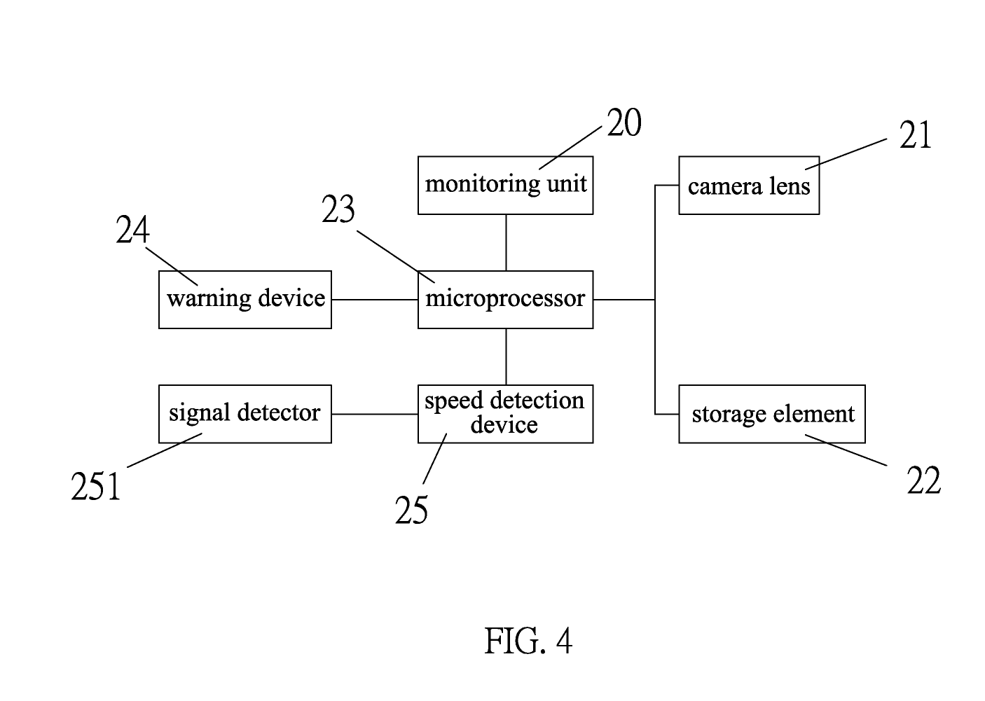

Referring to FIG. 4, an embodiment of the present invention is shown and in this embodiment, the monitoring unit 20 further comprises a microprocessor 23, a warning device 24, and a speed detection device 25. The microprocessor 23 is electrically connected to the camera lens 21, the storage element 22, and the warning device 24. The speed detection device 25 comprises a signal detector 251, such that when the signal detector 251 detects at least one radar or laser signal, through the operation of the microprocessor 23, the warning device 24 is activated.

The warning device 24 may further comprise at least one light emission element (not shown in the drawings) and a sound emission element (not shown in the drawings), such that lighting and sound may be given off as a reminder to the rider.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A structure for fixing a riding recorder with helmet visor fasteners, comprising:
a visor, which is provided, in inside thereof, with a plurality of first coupling members, such that the first coupling members are for attaching to a helmet; and
a monitoring unit, which is mounted to the visor, the monitoring unit comprising at least one camera lens and a storage element, such that through activation of the monitoring unit, the camera lens is operable for taking images and storing data of the images in the storage element.

2. The structure according to claim 1, wherein the monitoring unit further comprises a microprocessor, a speed detection device, and a warning device, the microprocessor being electrically connected to the camera lens, the storage element, and the warning device, the speed detection device comprising a signal detector, such that when the signal detector detects at least one external radar or laser signal, through operation of the microprocessor, the warning device is activated.

3. The structure according to claim 2, wherein the warning device further comprises at least one light emission element and a sound emission element for giving off lighting and sound alarms.

4. The structure according to claim 1, wherein the visor has an arc configuration and the visor has a bottom having a front edge that is recessed upwards to define a notch, the camera lens being received in the notch, the visor being further provided, on the bottom thereof, with a connection member that extends vertically downward, the first coupling members being respectively mounted to an inside surface of the connection member and inside surfaces of two ends of the visor, the helmet having a front surface on which a plurality of second coupling members is mounted such that the first coupling members and the second coupling members are selectively coupled to each other in a detachable manner

5. The structure according to claim 4, wherein the connection member of the visor and two side portions of the visor are respectively provided with a first adjustment hole and two second adjustment holes, the first coupling members being respectively arranged in the first adjustment hole and the second adjustment holes such that the first coupling members are movable in the first adjustment hole and the second adjustment holes for adjusting an angle of the camera lens.

6. The structure according to claim 4, wherein the first coupling members and the second coupling members are respectively male and female fasteners that mate each other.
